(19) United States
(12) Patent Application Publication
(10) Pub. No.: US 2015/0121072 A1
(43) Pub. Date: Apr. 30, 2015

(54) OBJECT VERIFICATION APPARATUS AND ITS INTEGRITY AUTHENTICATION METHOD

(71) Applicant: Electronics and Telecommunications Research Institute, Daejeon (KR)

(72) Inventors: Yang-Seo CHOI, Daejeon (KR); Ik-Kyun Kim, Daejeon (KR)

(73) Assignee: Electronics and Telecommunications Research Institute, Daejeon (KR)

(21) Appl. No.: 14/254,305

(22) Filed: Apr. 16, 2014

(30) Foreign Application Priority Data
Oct. 30, 2013 (KR) 10-2013-0130300

(51) Int. Cl. G06F 21/57; H04L 9/32; H04L 29/06

(52) U.S. Cl. CPC G06F 21/57; H04L 63/08; H04L 63/12; H04L 9/321
USPC 713/168; 726/7

(57) ABSTRACT

There is provided an object verification apparatus comprising; a communication module receiving object information to verify an object and integrity of the object, and requesting original object information to an integrity authentication server in which the original object information for the object is registered and receiving the original object information from the integrity authentication server; and a control module determining whether current object information extracted from the object and the object information are identical or not, controlling the communication module according to the determined result, and comparing the original object information and the current object information to verify the final integrity of the object.

### TECHNOLOGY FIELD

The present invention relates in general to an Object verification apparatus and its integrity authentication method and more particularly to an object verification apparatus and method which can easily authenticate integrity of an object being used in the field of information technology are provided.

### DESCRIPTIONS OF RELATED ARTS

There are various types of objects in the information technology environment and such objects are transmitted from a specific system or server to another system or server for a variety of reasons.

For example, when a general user tries to access to a bank website for banking, securities or encryption modules provided from the corresponding bank website are transmitted to the personal computer of the user through internet or when a user tries to update an application program or operating system, the corresponding update program or module is transmitted from an update server to the user. In addition, when a user searches for information, the search result is transmitted from a corresponding search server to the user and particular documents (for example, word files, PDF files, Hangul (Korean) files, image files, etc.) are transmitted from a server or system including the corresponding documents to a system which can download the documents. As another representative embodiment, smart devices (smart phones, tablet PCs, etc.) download, store and perform application programs for smart devices from application store (App store), a market or a website, etc.

As such, countless different kinds of software, documents, images and the like are being continuously transmitted and stored in the current information technology environment. The term “object” used in the present invention means all types of electronic information, documents, general files, executable files and the like which can be transmitted from one system to another system in the information technology environment.

Therefore, in this current situation where very diverse and many objects are transmitted, integrity authentication of such objects must be a very important factor. However, there is hardly discussed for any integrity authentication process for such objects. Some servers perform integrity for an object by providing MD5 hash value for the object, but there is no way to prove whether the provided hash value is extracted from a normal object or a tempered object or whether the provided hash value itself is tempered or not. Only it is in the level where a user believes that he/she uses integrity authentication information extracted by a normal object provider from a proper object. Besides, there are even few servers providing such a hash value.

The following problems may be caused when integrity of an object is not guaranteed.

Since a user cannot determine whether an object such as application programs or documents, which can be downloaded through internet or network, is normal or tempered, he/she may install malware by believing that the malware is a normal object. In the case of recent hacking attacks which cause very great harm such as system paralysis and failure, an attack is performed usually using malicious files which are disguised as normal programs to a user who downloads them. For example, the computer network attack of broadcasters and banks occurred in Mar. 20, 2013 in South Korea paralyzed the networks and was caused by a malicious program which was disguised as a normal program by a user and thus installed in the user's PC.

So far, there is no way to determine for a user whether an object which the user downloads through internet or network is proper or not. Some of malicious programs can be detected using known virus detection programs which only allow part of detections for already-known malicious files. Thus, it is impossible to detect malicious files which are very similar to normal files and unknown.

Accordingly, the integrity of objects should be verified by a user in real time, unlike detecting the already-known tempered files or malicious files by known virus detection programs. It is highly demanded to provide object integrity authentication to verify whether a particular object is an original one which is not tempered from the original object.

### SUMMARY

In one aspect, an object verification apparatus and its integrity authentication method which can easily authenticate integrity of an object being used in the field of information technology is provided.

In another aspect, an object verification apparatus and method for authenticating integrity of an object using an integrity authentication server (Object Integrity Authentication Infrastructure with Trusted Organization) which allows a user to verify whether files are tempered or not before installing, running or opening the files and thus to use only normal objects to prevent essentially from malicious acts.

In an embodiment, an object verification apparatus may include a communication module receiving object information to verify an object and integrity of the object, and requesting original object information to an integrity authentication server in which the original object information for the object is registered and receiving the original object information from the integrity authentication server; and a control module determining whether current object information extracted from the object and the object information are identical or not, controlling the communication module according to the determined result, and comparing the original object information and the current object information to verify the final integrity of the object.

The object information according to an embodiment may include at least one of an object name, an object size, an object generation time, an object version, a hash value and other information which can represent characteristics of the object.

The object information according to an embodiment may be encrypted by a personal encryption key of an object generation apparatus which generates the object.

The communication module according to an embodiment may request for and receives the object, the object information and the original object information according to the control of the control module.

The object information according to an embodiment may be encrypted by a personal encryption key of an object generation apparatus which generates the object, and the original object information is encrypted by a server encryption key set up after verifying the integrity by decrypting the object information distributed from the object generation apparatus by a public decryption key which is corresponding to the personal encryption key.

The control module according to an embodiment may include: an extracting unit extracting the current object information from the object; a decrypting unit decrypting the object information and the original object information by a predetermined decryption key; and a control determining unit determining the final integrity for the object by determining whether the current object information and the object information are identical and whether the current object information and the original object information are identical.

The control determining unit according to an embodiment may discard the object and the object information when the current object information and the object information are not identical or when the current object information and the original object information are not identical.

The control determining unit according to an embodiment verifies the integrity for the object and executes the object when the current object information and the object information are identical and when the current object information and the original object information are identical.

An integrity authentication method of an object verification apparatus according to an embodiment comprises: when object information is inputted to verify an object distributed from an object generation apparatus and the integrity of the object, determining whether the current object information extracted from the object and the object information are identical; when the current object information and the object information are identical, requesting the original object information for the object registered in an integrity authentication server; and final determining the integrity for the original object information delivered from the integrity authentication server and the current object information.

The integrity authentication method of an object verification apparatus according to an embodiment further may include discarding the object and the object information when the current object information and the object information are not identical after the determining step.

The object information according to an embodiment is encrypted by a personal encryption key of an object generation apparatus which generates the object, and the original object information is encrypted by a predetermined server encryption key after verifying the integrity by decrypting the object information distributed from the object generation apparatus by a public decryption key which is corresponding to the personal encryption key.

The determining step according to an embodiment may include extracting the current object information; and decrypting the object information.

The verifying step according to an embodiment may include decrypting the original object information and comparing whether the decrypted original object information and the current object information are identical; and when the original object information and the current object information are identical, finally verifying the integrity of the object and executing the object.

The executing step according to an embodiment discards the object and the object information when the original object information and the current object information are not identical.

When a user uses various types of objects through internet or network, the object verification apparatus and its integrity authentication method according to an embodiment allows the user to verify the integrity of a particular object so that it eliminates any problem associated with installing or storing the object of which integrity is intruded.

The object verification apparatus and its integrity authentication method according to an embodiment is able to prevent in advance from installing or storing objects including virus and/or malicious files in a system through the integrity authentication.

### BRIEF DESCRIPTION OF DRAWINGS

FIG. 1 is a system diagram illustrating an object integrity authentication system including an object verification apparatus according to an embodiment.

FIG. 2 is a control block diagram illustrating a control configuration of an object verification apparatus according to an embodiment.

FIG. 3 is a flowchart illustrating an integrity authentication method of an object verification apparatus according to an embodiment.

### DETAILD DESCRIPTION

The description below is to illustrate only the principle of the invention. Thus, it is to be appreciated that various devices included in the scope and spirit of the invention may be made by those skilled in the art although it is not described in detail or shown in the descriptions. All conditional terms and embodiments are only for explanation and there is no intention to limit the invention.

In addition, it is to be appreciated that not only the principle, views and embodiments but also the detailed descriptions used in the embodiments may be intended to include their structural and functional equivalents. It is also to be appreciated that such equivalents may include the currently known equivalents as well as equivalents to be developed in the future which include all elements invented to perform the same functions (works) regardless of the structure.

Therefore, for example, it is to be appreciated that the block diagram illustrated herein is a specific conceptual exemplary view showing the principle of the invention. Similarly, it is also to be appreciated that all flowcharts, views, codes and the like can be used substantially to computer readable medium and can be used to various processors being executed in computers or processors regardless of whether computers or processors are explicitly illustrated or not.

Functions of various elements illustrated in the drawings including processors or its similar function blocks can be provided through use of not only dedicated hardware but also hardware being capable of executing software. When it is provided by a processor, the functions can be provided by a single dedicated processor, a single shared processor or a plurality of individual processors and some of these can be shared.

It is to be appreciated that the terms of processor, control or any term used for similar concepts thereof should not be construed to exclusively quote hardware being capable of executing software but implicitly include digital signal processors (DSP) hardware, ROMs, RAMs and non-volatile memories which can store software. It also includes other well-known hardware.

It is to be appreciated that all elements presented as units to perform the functions described in the present invention may include all combinations of circuit elements performing the functions or all methods performing the functions including all types of software and may be combined with appropriate circuits which perform the software to execute the functions. It is also to be appreciated that since the functions provided by the listed means may be combined and also combined with the methods in the invention, any means which is able to provide the functions may be included in the present invention.

While the present invention has been described with reference to particular embodiments, it is to be appreciated that various changes and modifications may be made by those skilled in the art without departing from the spirit and scope of the present invention, as defined by the appended claims and their equivalents. Throughout the description of the present invention, when describing a certain technology is determined to evade the point of the present invention, the pertinent detailed description will be omitted.

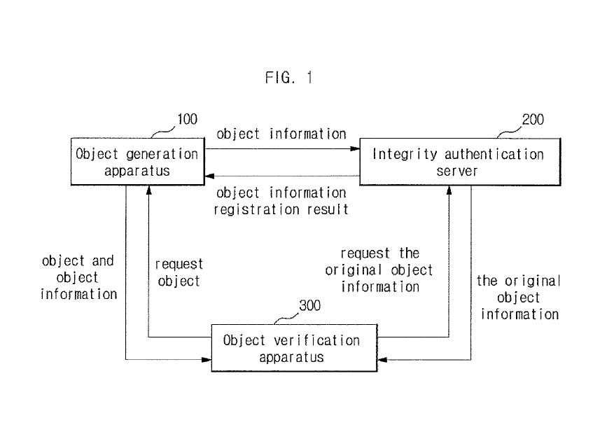

FIG. 1 is a system diagram illustrating an object integrity authentication system including an object verification apparatus according to an embodiment.

Referring to FIG. 1, the object integrity authentication system may include an object generation apparatus 100, an integrity authentication server 200 and an object verification apparatus 300.

The object generation apparatus 100 generates objects which include all types of electronic information, documents, general files, executable files and the like which can be transmittable from one system to another system in the information technology environment.

In an embodiment, the object generation apparatus 100 may include at least one of a server, a computer, and a website but it is not limited thereto.

Here, the object generation apparatus 100 extracts object information to verify or prove the integrity of the object after generating the object and encrypts it by a predetermined encryption key.

The object information may include at least one of an object name, an object size, an object generation time, an object version and a hash value but it is not limited thereto.

Here, the object generation apparatus 100 transmits the object information to the integrity authentication server 200.

The object generation apparatus 100 can transmit the object information to the integrity authentication server 200 through online or offline, but it is not limited thereto.

The integrity authentication server 200 extracts the original object information after the object information transmitted from the object generation apparatus 100 is decrypted by the public key, which is corresponding to the encryption key, and determines whether the original object information is generated by the object generation apparatus 100.

In other words, the integrity authentication server 200 determines whether the original object information is generated in the object generation apparatus 100 and when it is determined that the original object information is generated by the object generation apparatus 100, it registers or stores the original object information and transmits the result to the object generation apparatus 100.

The object generation apparatus 100 can then distribute the object and the object information based on the result transmitted from the integrity authentication server 200 when the object verification apparatus 300 requests it.

The object verification apparatus 300 requests the object to the object generation apparatus 100 and receives the object and the encrypted object information from the object generation apparatus 100.

The object verification apparatus 300 compares the current object information extracted from the object with the decrypted object information and determines whether the current object information and the object information are identical or not.

The object verification apparatus 300 then requests the original object information for the object to the integrity authentication server 200 when the current object information and the object information are identical.

Here, the integrity authentication server 200 encrypts the original object information and then transmits the encrypted one, when the registered original object information exists, with the request of the original object information from the object verification apparatus 300, while it informs that the original object information is not registered when the original object information does not exist.

The object verification apparatus 300 decrypts the encrypted original object information transmitted from the integrity authentication server 200 and determines whether the original object information and the current object information are identical or not.

The object verification apparatus 300 verifies the final integrity of the object when the original object information and the current object information are identical, and then determines to execute access and read the object according to user's commands.

In an embodiment, the object verification apparatus 300 may be terminals allowing communication and communication devices such as computers, notebooks, smart phones and the like, but it is not limited thereto.

In addition, in an embodiment, even though any encryption method is not used, if each of the object generation apparatus 100, the integrity authentication server 200, and the object verification apparatus 300 is justified as an authentication method, any method can be used, but it is not limited thereto.

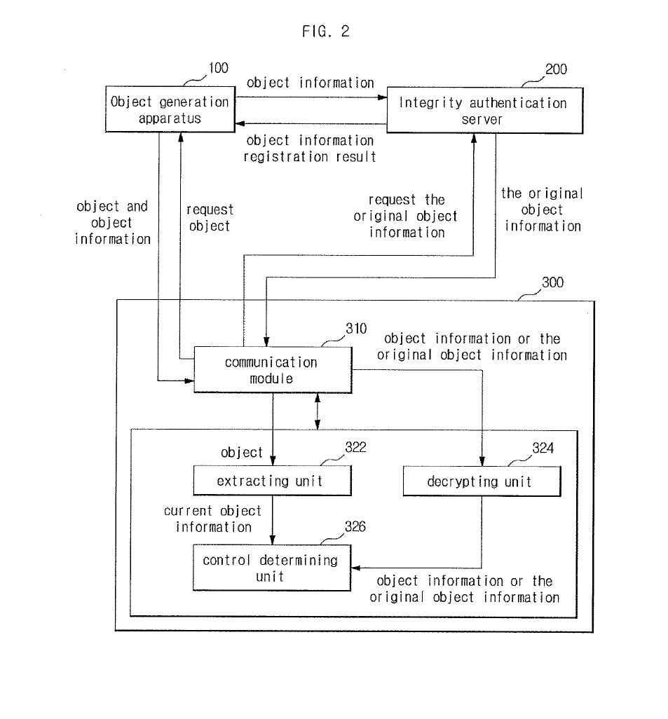

FIG. 2 is a control block diagram illustrating a control configuration of an object verification apparatus according to an embodiment.

Referring to FIG. 2, the object verification apparatus 300 may include a communication module 310 and a control module 320.

The communication module 310 can request an object to the object generation apparatus 100, receives object information to verify the integrity of the object from the object generation apparatus 100, and request to and receive from the integrity authentication server 200 the original object information for the object.

Here, the communication module 310 may be a communication module being capable of data communications, request the object and the original object information according to the control of the control module 320, and receive the object, the object information and the original object information.

The object information can be encrypted by a personal encryption key of the object generation apparatus and the original object information can be encrypted by a predetermined server encryption key after the object information transmitted from the object generation apparatus is decrypted by the public decryption key which is corresponding to the personal encryption key and verified for the integrity.

The control module 320 can control the communication module 310 to request to and receive from the object generation apparatus 100 the object according to a user's command, but it is not limited thereto.

The control module 320 may include: an extracting unit 322 extracting current object information from the object; a decrypting unit 324 decrypting the object information and the original object information according to a predetermined encryption key; and a control determining unit determining the final integrity for the object by determining whether the current object information and the object information are identical and whether the current object information and the original object information are identical.

The extracting unit 322 can extract current object information from the object and the current object information can be identical information to the object information described in FIG. 1.

Here, the decrypting unit 324 decrypts at least one of the object information and the original object information and transmits the result to the control determining unit 326.

The control determining unit 326 determines whether the current object information extracted from the extracting unit 322 and the object information decrypted from the decrypting unit 324 are identical or not.

In other words, the control determining unit 326 requests the original object information for the object to the integrity authentication server 200 by controlling the communication module 310 and receives the original object information transmitted from the integrity authentication server 200 and decrypted at the decrypting unit 324 when the current object information and the object information are identical.

The control determining unit 326 then verifies the final integrity of the object when the original object information and the current object information are identical, and then determines to execute, access and read the object.

The control determining unit 326 discards at least one of the object and the object information when the current object information and the object information are not identical or when the current object information and the original object information are not identical.

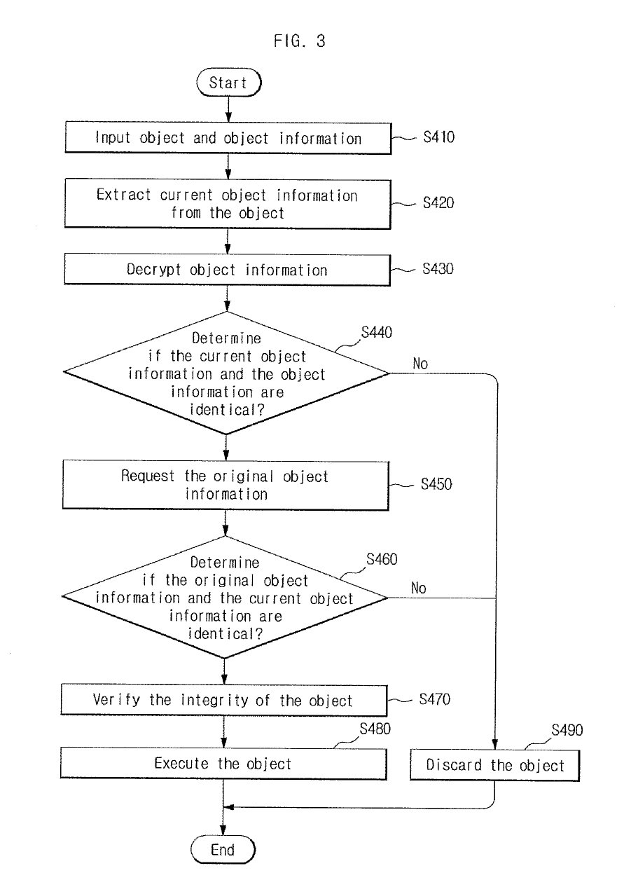

FIG. 3 is a flowchart illustrating an integrity authentication method of an object verification apparatus according to an embodiment.

Referring to FIG. 3, the object verification apparatus 300 receives the object transmitted from the object generation apparatus 100 and the object information to verify the integrity of the object (S410), extracts current object information from the object (S420), and decrypts the object information (S430).

In other words, the object verification apparatus 300 requests an object to the object generation apparatus 100 and receives the object and object information to verify the integrity of the object from the object generation apparatus 100.

Here, the object verification apparatus 300 extracts current object information from the object and decrypts the object information by a predetermined decryption key.

The object generation apparatus 100 generates the object, extracts object information to verify or prove the integrity of the object and encrypts according to a predetermined encryption key.

The object information may include at least one of an object name, an object size, an object generation time, an object version and a hash value for the object. In addition, the object information may comprise any information which can represent characteristics of the object, but it is not limited thereto.

Here, the object generation apparatus 100 transmits the object information to the integrity authentication server 200.

The integrity authentication server 200 extracts the original object information after the object information transmitted from the object generation apparatus 100 is decrypted by the public key which is corresponding to the encryption key, and determines whether the original object information is generated by the object generation apparatus 100.

The integrity authentication server 200 determines whether the original object information is generated in the object generation apparatus 100 and when it is determined that the original object information is generated by the object generation apparatus 100, it registers or stores the original object information and transmits the result to the object generation apparatus 100.

Here, the object generation apparatus 100 can then release the object and the object information based on the result transmitted from the integrity authentication server 200 with the request from the object verification apparatus 300.

The object verification apparatus 300 determines whether the current object information and the object information are identical or not (S440), and then requests the registered original object information for the object to the integrity authentication server 200 (S450) when the current object information and the object information are identical.

In other words, the object verification apparatus 300 requests the original object information for the object to the integrity authentication server 200 by controlling the communication module 310 when the current object information and the object information are identical.

Here, the integrity authentication server 200 encrypts the original object information and then transmits the encrypted one, when the registered original object information exists, with the request of the original object information from the object verification apparatus 300, while it informs that the original object information is not registered when the original object information does not exist.

The object verification apparatus 300 decrypts the encrypted original object information when the original object information is transmitted from the integrity authentication server 200, and then compares whether the original object information and the current object information are identical or not (S460). When the original object information and the current object information are identical, it verifies the final integrity of the object (S470), and is then able to execute the object according to user's commands (S480).

Also, when the current object information and the object information are not identical after the S440 or when the current object information and the original object information are not identical after S460, the object verification apparatus 300 discards at least one of the object and the object information (S490).

In other words, the object verification apparatus 300 decrypts the original object information transmitted from the integrity authentication server 200 and encrypted and determines whether the original object information and the current object information are identical.

The object verification apparatus 300 verifies the final integrity of the object when the original object information and the current object information are identical, and is then able to execute, access and/or read the object according to user's commands.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

### DESCRIPTION OF REFERENCE NUMBERALS

100: object generation apparatus

200: integrity authentication server

300: object verification apparatus

What is claimed is:

1. An object verification apparatus comprising;
a communication module receiving object information to verify an object and integrity of the object, and requesting original object information to an integrity authentication server in which the original object information for the object is registered and receiving the original object information from the integrity authentication server; and
a control module determining whether current object information extracted from the object and the object information are identical or not, controlling the communication module according to the determined result, and comparing the original object information and the current object information to verify the final integrity of the object.

2. The object verification apparatus of claim 1, wherein the object information comprises at least one of an object name, an object size, an object generation time, an object version and a hash value.

3. The object verification apparatus of claim 1, wherein the object information is encrypted by a personal encryption key of an object generation apparatus which generates the object.

4. The object verification apparatus of claim 1, wherein the communication module requests for and receives the object, the object information and the original object information according to the control of the control module.

5. The object verification apparatus of claim 1, wherein the object information is encrypted by a personal encryption key of an object generation apparatus which generates the object, and
the original object information is encrypted by a predetermined server encryption key after verifying the integrity by decrypting the object information distributed from the object generation apparatus by a public decryption key which is corresponding to the personal encryption key.

6. The object verification apparatus of claim 5, wherein the control module comprises:
an extracting unit extracting the current object information from the object;
a decrypting unit decrypting the object information and the original object information by a predetermined decryption key; and
a control determining unit determining the final integrity for the object by determining whether the current object information and the object information are identical and whether the current object information and the original object information are identical.

7. The object verification apparatus of claim 6, wherein the control determining unit discards the object and the object information when the current object information and the object information are not identical or when the current object information and the original object information are not identical.

8. The object verification apparatus of claim 6, wherein the control determining unit verifies the integrity for the object and executes the object when the current object information and the object information are identical and when the current object information and the original object information are identical.

9. An integrity authentication method of an object verification apparatus, the method comprising:
when object information is inputted to verify an object distributed from an object generation apparatus and the integrity of the object, determining whether the current object information extracted from the object and the object information are identical;
when the current object information and the object information are identical, requesting original object information for the object registered in an integrity authentication server; and
finally determining the integrity for the original object information delivered from the integrity authentication server and the current object information.

10. The integrity authentication method of claim 9, further comprising discarding the object and the object information when the current object information and the object information are not identical after the determining step.

11. The integrity authentication method of claim 9, wherein the object information is encrypted by a personal encryption key of an object generation apparatus which generates the object, and
the original object information is encrypted by a predetermined server encryption key after verifying the integrity by decrypting the object information distributed from the object generation apparatus by a public decryption key which is corresponding to the personal encryption key.

12. The integrity authentication method of claim 11, wherein the determining step comprises extracting the current object information; and
decrypting the object information.

13. The integrity authentication method of claim 11, wherein the verifying comprises decrypting the original object information and comparing whether the decrypted original object information and the current object information are identical; and
when the original object information and the current object information are identical, finally verifying the integrity of the object and executing the object.

14. The integrity authentication method of claim 13, wherein, in the executing, the object and the object information are discarded when the original object information and the current object information are not identical.
